(19) United States
(12) Patent Application Publication
(10) Pub. No.: US 2021/0147077 A1
(43) Pub. Date: May 20, 2021

(54) Localization Device and Localization Method for Unmanned Aerial Vehicle

(71) Applicant: Autonomous Control Systems Laboratory Ltd., Edogawa-ku, Tokyo (JP)

(72) Inventors: Christopher Thomas Raabe, Chuo-ku, Tokyo (JP); Shosuke Inoue, Shinjuku-ku, Tokyo (JP)

(21) Appl. No.: 17/045,037

(22) PCT Filed: Apr. 3, 2018
(86) PCT No.: PCT/JP2018/014207

§ 371 Date: Oct. 2, 2020

(51) Int. Cl. B64C 39/02; G01S 17/89; G05D 1/10; G05D 1/00; G08G 5/00

(52) U.S. Cl. CPC B64C 39/024; G01S 17/89; B64C 2201/141; G05D 1/0094; G08G 5/0069; G05D 1/101

(57) ABSTRACT

Improved localization processing for an unmanned aerial vehicle is provided.

The foregoing problem is solved by a localization device for an unmanned aerial vehicle including a light source for irradiating a target object around the unmanned aerial vehicle, a light-collecting sensor for acquiring reflected light from the target object as image data, and a localization unit for estimating a relative position of the unmanned aerial vehicle to the target object using the image data acquired by the light-collecting sensor, wherein the light source includes a laser for emitting light distinguishable from ambient light, and a diffuser for diffusing the light from the laser, and the light-collecting sensor is configured to sense light distinguishable from ambient light with respect to reflected light from the target object.

### TECHNICAL FIELD

The present invention relates to an unmanned aerial vehicle, and more particularly to a localization device and a localization method for an unmanned aerial vehicle.

### BACKGROUND ART

Conventionally, an unmanned aerial vehicle has been operated to fly by an operator transmitting a control signal from a control transmitter on the ground to the unmanned aerial vehicle in the sky, or autonomously fly according to a flight plan by installing an autonomous control device therein.

In recent years, various autonomous control devices for causing unmanned aerial vehicles including a fixed-wing aircraft and a rotorcraft to autonomously fly have been developed. There has been proposed an autonomous control device including sensors for detecting the position, attitude, altitude, and heading of a small unmanned helicopter, a main computing unit for computing a control command value for a servo motor for moving the rudder of the small unmanned helicopter, and a sub computing unit for collecting data from the sensors and converting a computation result obtained by the main computing unit into a pulse signal for the servo motor, the sensors, the main computing unit and the sub computing unit being assembled in one small frame box.

With respect to an unmanned aerial vehicle including an autonomous control device, the position (altitude) of the unmanned aerial vehicle can be estimated based on three-dimensional map data generated by using Visual SLAM (Simultaneous Localization and Mapping).

Further, as for unmanned aerial vehicles, as described in Patent Literature 1, an unmanned aerial vehicle has been developed which is equipped with a light source to control the unmanned aerial vehicle.

### CITATION LIST

### Patent Literature

[Patent Literature 1] Japanese Patent Laid-Open No. 2017-224123

In the Visual SLAM (VSLAM), feature points are tracked based on video images from a camera to estimate the position of an unmanned aerial vehicle (drone) and create environmental map data. In this case, for regions having the same feature, the estimation is performed while they are regarded as the same target object.

In this respect, if illumination is not sufficiently emitted during imaging of a surrounding environment of the unmanned aerial vehicle, it causes a shortage in exposure amount or a deterioration in contrast. Further, a scene to be imaged may include a shadow. In this case, a shadow region also has an insufficient exposure amount, and the contrast is deteriorated. On the other hand, a region other than the shadow region may reach a saturated exposure amount, so that the contrast may be deteriorated. When the drone's shadow moves together with the drone, it moves feature points, which will be detrimental to position estimation algorithms such as VSLAM.

For example, as shown in FIG. 7, when a target object has a shadow (a hatched area in the drawing), the shadow region is recognized as a region having another feature, so that a situation in which feature points of the target object cannot be accurately recognized may occur. A situation in which a shadow occurs on a target object as described above is likely to occur in a case where a large step exists on the target object, in an environment in which a plurality of light sources exist, or in a case where another object exists outdoors between sunlight and the target object.

### SUMMARY OF INVENTION

### Technical Problem

Therefore, it is desirable to provide a device or the like that can estimate the position of an unmanned aerial vehicle with respect to a target object by reducing the influence of sunlight or an external light source and its accompanying shadow. Further, it is desirable that the position of an unmanned aerial vehicle with respect to a target object having a step or the like can be accurately estimated.

### Solution to Problem

The present invention has been made in view of the foregoing problem, and has the following features. According to one feature of the present invention, there is provided a localization device for an unmanned aerial vehicle that comprises: a light source for irradiating a target object around the unmanned aerial vehicle; a light-collecting sensor for acquiring reflected light from the target object as image data; and a localization unit for estimating a relative position of the unmanned aerial vehicle to the target object using the image data acquired by the light-collecting sensor, wherein the light source includes a laser for emitting light distinguishable from ambient light, and a diffuser for diffusing the light from the laser, and the light-collecting sensor is configured to sense light distinguishable from the ambient light with respect to reflected light from the target object.

The present invention may further comprise a light source controller for adjusting at least one of emission intensity, position and direction of the laser.

In the present invention, the light distinguishable from the ambient light may be light of a predetermined band, and the light-collecting sensor may be configured to sense the light of the predetermined band. The predetermined band may include a plurality of hands, and the light-collecting sensor may be configured to sense each of signals of the plurality of bands. The light source may be configured so as to apply light that is different in intensity among the plurality of bands, and the light-collecting sensor may be configured to select which band of light is to be sensed according a distance to the target object. The light-collecting sensor may be configured to be able to select which band of light is to be sensed for each pixel or for each predetermined region in an image.

In the present invention, the diffuser may include a wide-angle lens. The diffuser may be configured to form light which is emitted such that light projected from a circumferential portion of the wide-angle lens is brighter than light projected from a center portion.

The present invention may further comprise, in front of the diffuser, a phosphor reflector for converting a coherent laser into an incoherent spectrum.

In the present invention, flight of the unmanned aerial vehicle may be controlled by using a relative position of the unmanned aerial vehicle with respect to the target object estimated by the localization device and a speed of the unmanned aerial vehicle.

According to another feature of the present invention, there is provided a method comprising: a step of emitting light distinguishable from ambient light from a laser used as a light source: a step of diffusing the emitted light to irradiate a target object around an unmanned aerial vehicle; a step of collecting reflected light from the target object to acquire image data; and a step of estimating a relative position of the unmanned aerial vehicle to the target object by using the acquired image data, wherein the step of acquiring the image data acquires the image data by sensing light distinguishable from the ambient light with respect to reflected light from the target object.

The present invention may further comprise a step of setting at least one of emission intensity, position and direction of the light source, wherein the emitting step, the step of irradiating the target object, the step of acquiring the image data, and the estimating step may be executed by using the set light source.

In the present invention, light distinguishable from the ambient light may be light of a predetermined band, and the step of acquiring the image data may acquire the image data by sensing the light of the predetermined band.

In the present invention, the predetermined band may have a plurality of bands, and the step of acquiring the image data may sense each of signals of the plurality of bands. The irradiating step may apply light that is different in intensity among the plurality of bands, and the step of acquiring the image data may further comprise a step of selecting which band of light is to be sensed according to a distance to the target object. The step of acquiring the image data may further comprise a step of selecting which band of light is to be sensed for each pixel or for each predetermined region in an image.

### Advantageous Effect of Invention

According to the present invention, it is possible to estimate the position of an unmanned aerial vehicle that is not affected by an external light source. Further, in an autonomous unmanned aerial vehicle having no GPS function, it is possible to efficiently and accurately estimate the position of the autonomous unmanned aerial vehicle.

### BRIEF DESCRIPTION OF DRAWINGS

FIG. 1 is a perspective view of an unmanned aerial vehicle according to an embodiment of the present invention.

FIG. 2 is a view taken when the unmanned aerial vehicle of FIG. 1 is viewed from below.

FIG. 3 is a block diagram showing an example of a configuration of the unmanned aerial vehicle of FIG. 1.

FIG. 4 is a diagram showing an example of an optical structure of a light source for the unmanned aerial vehicle of FIG. 1.

FIG. 5 is a flowchart showing an example of position estimation processing of the unmanned aerial vehicle.

FIG. 6 is an example of actual irradiation by the light source of FIG. 4.

FIG. 7 is a diagram showing the state of a shadow of a target object to be imaged by the unmanned aerial vehicle.

### DESCRIPTION OF EMBODIMENT

### Configuration of Unmanned Aerial Vehicle

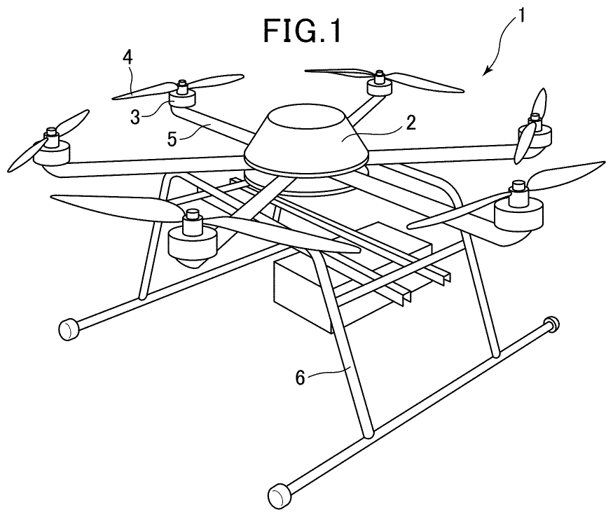

FIG. 1 is a diagram showing an external appearance of an unmanned aerial vehicle (multicopter) 1 according to an embodiment of the present invention.

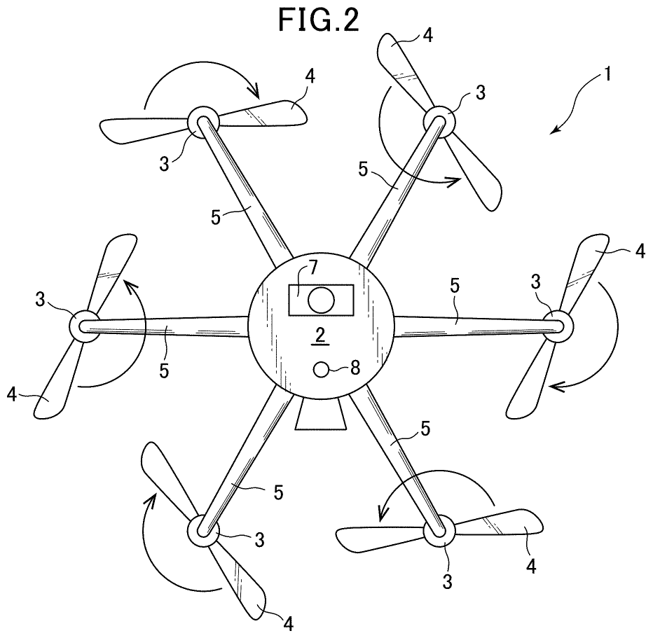

FIG. 2 is a bottom diagram showing the unmanned aerial vehicle (multicopter) 1 of FIG. 1.

The unmanned aerial vehicle 1 includes a main body portion 2, six motors 3, six rotors (rotor blades) 4, six arms 5 for connecting the main body portion 2 and the respective motors 3, landing legs 6, and a local sensor 7.

The six rotors 4 are driven to rotate by the respective motors 3, thereby generating dynamic lift. The main body portion 2 controls the driving of the six motors 3 to control the number of revolutions and the direction of rotation of each of the six rotors 4, thereby controlling flying of the unmanned aerial vehicle 1 such as ascending, descending, moving back/forth and right/left, and turning. The landing legs 6 contribute to prevention of overturning of the unmanned aerial vehicle 1 during takeoff and landing, and protect the main body portion 2, the motors 3 and the rotors 4 of the unmanned aerial vehicle 1.

The local sensor 7 uses a laser light source 8 to measure an environmental condition around the unmanned aerial vehicle 1. The local sensor 7 is capable of measuring the distances to objects around the unmanned aerial vehicle 1 using information obtained by mainly irradiating a target object with laser light downward from a light source 8 and reflecting the laser light from the target object, and creating the shapes of the objects around the unmanned aerial vehicle 1. The irradiation direction of the laser light is one example, but it is preferable to include at least the downward direction. As described above, in the present embodiment, the local sensor 7 is a sensor to be used to measure the relative position of the unmanned aerial vehicle 1 with respect to the objects around the unmanned aerial vehicle 1, and any sensor may be used as long as it can measure the positional relationship with objects around the unmanned aerial vehicle 1. Therefore, for example, only one laser may be used or a plurality of lasers may be used. Further, the local sensor 7 may be, for example, an image sensor. The local sensor 7 described above is preferably used when the SLAM technique is used.

For example, when the local sensor 7 is an image sensor, the unmanned aerial vehicle 1 includes an imaging device. The imaging device includes a monocular camera or a stereo camera, which is configured by an image sensor or the like, and images the surroundings of the unmanned aerial vehicle 1 to acquire a video or an image of the surroundings of the unmanned aerial vehicle 1. In this case, it is preferable that the unmanned aerial vehicle 1 includes a motor capable of changing the orientation of the camera, and a flight control device 11 controls the operation of the camera and the motor. For example, the unmanned aerial vehicle 1 acquires images sequentially by using a monocular camera, or acquires images by using a stereo camera, and analyzes the acquired images to obtain information on the distances to surrounding objects and the shapes of the objects. The imaging device may be an infrared depth sensor capable of acquiring shape data by projection of infrared ray.

The local sensor 7 will be described as being attached to the outside of the main body portion 2, but the local sensor 7 may be mounted inside the main body portion 2 as long as it can measure the positional relationship between the unmanned aerial vehicle 1 and the surrounding environment.

### Summary of System

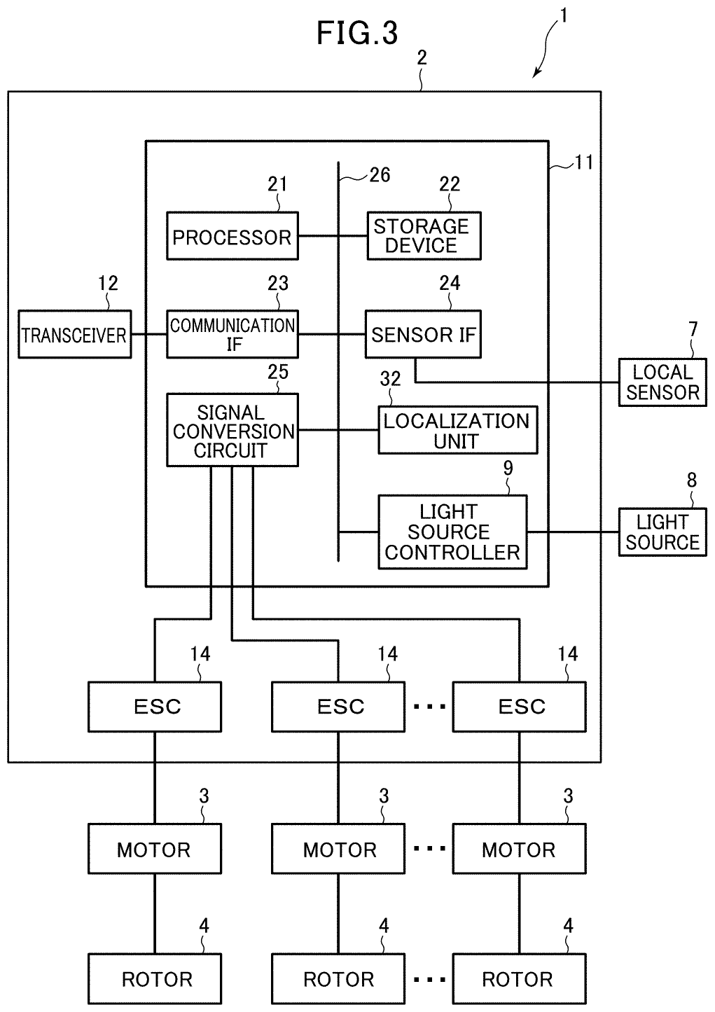

FIG. 3 is a diagram showing a hardware configuration of the unmanned aerial vehicle 1 of FIGS. 1 and 2. The main body portion 2 of the unmanned aerial vehicle 1 includes a flight control device (flight controller) 11, a transceiver 12, a sensor 13, a speed controller (ESC: Electric Speed Controller) 14, and a battery power supply (not shown).

The transceiver 12 transmits and receives various data signals to and from the outside, and includes an antenna. For convenience of description, the transceiver 12 will be described in the form of one device, but a transmitter and a receiver may be installed separately from each other.

The flight control device 11 performs arithmetic processing based on various information to control the unmanned aerial vehicle 1. The flight control device 11 includes a processor 21, a storage device 22, a communication IF 23, a sensor IF 24, and a signal conversion circuit 25. These units are connected to one another via a bus 26

The processor 21 is adapted to control the overall operation of the flight control device 11, and it is, for example, a CPU. Note that an electronic circuit such as MPU may be used as the processor. The processor 21 executes various processing by reading and executing programs and data stored in the storage device 22.

The storage device 22 includes a main storage device and an auxiliary storage device. The main storage device is a semiconductor memory such as RAM. RAM is a volatile storage medium that can read and write information at high speed, and is used as a storage region and a work region when the processor processes information. The main storage device may include ROM that is a read-only nonvolatile storage medium. In this case, the ROM stores programs such as firmware. The auxiliary storage device stores various programs and data to be used by the processor 21 when each program is executed. The auxiliary storage device is, for example, a hard disk device. However, it may be any non-volatile storage or non-volatile memory as long as it can store information, and may be attachable and detachable. The auxiliary storage device stores, for example, an operating system ((OS), middleware, application programs, various data that can be referred to as the programs are executed, and the like.

The communication IF 23 is an interface for connection to the transceiver 12. The sensor IF 24 is an interface for inputting data acquired by the local sensor 7. For convenience of description, each IF will be described as one IF, but it is understood that different IFs may be provided to devices or sensors, respectively.

The signal conversion circuit 25 generates a pulse signal such as a PWM signal, and transmits the pulse signal to ESC 14. The ESC 14 converts the pulse signal generated by the signal conversion circuit 25 into a drive current for the motors 3, and supplies the current to the motors 3.

The battery power source is a battery device such as a lithium polymer battery or a lithium ion battery, and supplies power to each component. Note that a large power supply is required to operate the motors 3, and thus the ESC 14 is preferably directly connected to the battery power supply to adjust the voltage or the current of the battery power supply, and supplies the drive current to the motors 3.

Preferably, the storage device 22 stores a flight control program in which a flight control algorithm for controlling the attitude and basic flight operation of the unmanned aerial vehicle 1 during flight is installed. When the processor 21 executes the flight control program, the flight control device 11 performs arithmetic processing so as to achieve set target altitude and target speed, and calculates the number of revolutions of each motor 3 and the rotation speed of each motor 3 to calculate control command value data. At this time, the flight control device 11 acquires various information such as the attitude of the unmanned aerial vehicle 1 during flight from various sensors, and performs arithmetic processing based on the acquired data and the set target altitude and target speed.

The signal conversion circuit 25 of the flight control device 11 converts the control command value data calculated as described above into a PWM signal, and sends the PWM signal to the ESC 14. The ESC 14 converts the signal received from the signal conversion circuit 25 into a drive current for the motors 3 and supplies the drive current to the motors 3 to rotate the motors 3. In this way, the main body portion 2 including the flight control device 11 controls the rotation speeds of the rotors 4, and controls the flight of the unmanned aerial vehicle 1.

In one example, the flight control program includes parameters such as a flight route including latitude, longitude and altitude and a flight speed, and the flight control device 11 sequentially determines a target altitude and a target speed, and performs the above-described arithmetic processing, thereby causing the unmanned aerial vehicle 1 to autonomously fly.

In one example, the flight control device 11 receives a command such as ascending/descending and moving forward/backward from an external transmitter via the transceiver 12 to determine the target altitude and the target speed, and performs the above-described arithmetic processing, thereby controlling the flight of the unmanned aerial vehicle 1.

### Localization Processing

The localization unit 32 localizes the unmanned aerial vehicle 1 based on point cloud data of image data of objects around the unmanned aerial vehicle 1 acquired by using the local sensor 7 as a light-collecting sensor. The self-position estimated by the localization unit 32 is a relative position of the unmanned aerial vehicle 1 with respect to the objects around the unmanned aerial vehicle 1. In the present embodiment, the localization unit 32 localizes the unmanned aerial vehicle 1 by using the SLAM technique. Since the SLAM technique is a known technique, description thereof will be omitted. However, the local sensor 7 is used to recognize to surrounding objects, and simultaneously perform localization and mapping based on the object recognition result.

In the present embodiment, the localization unit 32 estimates and outputs the relative position (altitude) of the unmanned aerial vehicle 1 by using the SLAM technique.

The localization unit 32 acquires point cloud data around the unmanned aerial vehicle 1 by using a light source described later. The localization unit 32 starts the localization processing when point cloud data for which a measured distance by laser light emitted from the light source is within a predetermined distance range (for example, 0.1 to 20 m) can be acquired, and sets, as a reference coordinate, the self-position at a timing when acquisition of the point cloud data starts. Then, the localization unit 32 uses the acquired point cloud data to perform localization while performing mapping.

The localization unit 32 acquires an image by using an imaging device such as a camera, extracts, as feature points, the positions of an object or points on the surface in the acquired image, and performs matching between an extracted pattern and a pattern of a created map (or an acquired point cloud).

The localization unit 32 performs localization based on the degree of coincidence between the created map and the point cloud data acquired using the laser light source. The localization unit 32 is configured to estimate and output the relative altitude of the unmanned aerial vehicle 1 when the unmanned aerial vehicle 1 collects sufficient point cloud data.

### Light Source

As shown in FIG. 2, the light source 8 is desirably attached so as to face downward from the bottom side of the unmanned aerial vehicle so that the condition near the ground surface can be grasped. However, the light source is required only to be configured so that it can illuminate the vicinity of the ground surface, and may be attached to another position of the unmanned aerial vehicle.

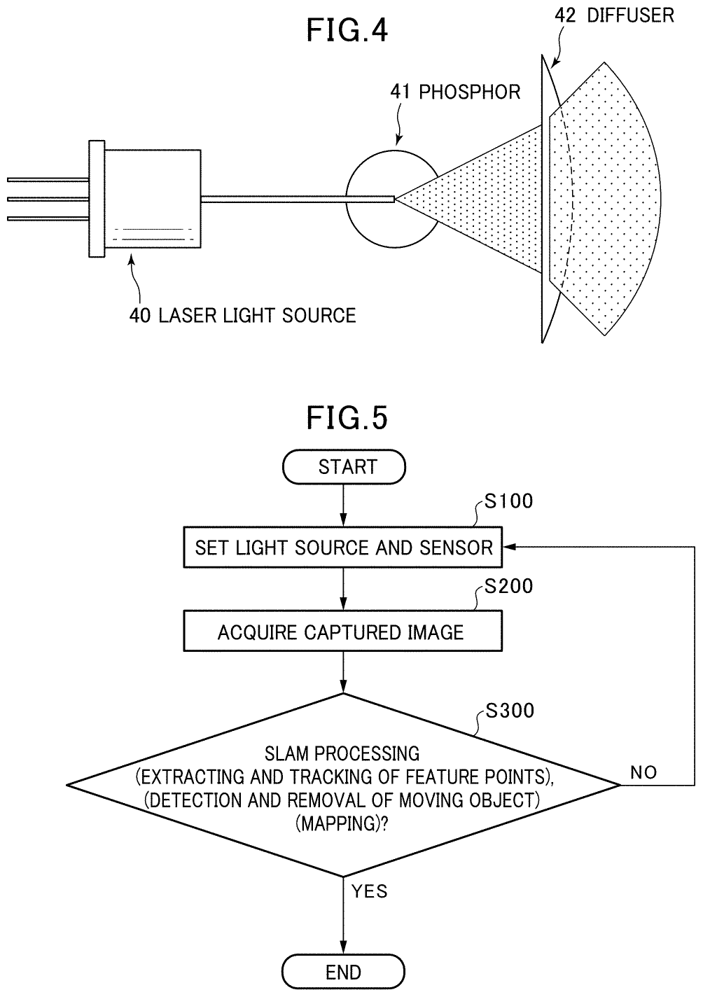

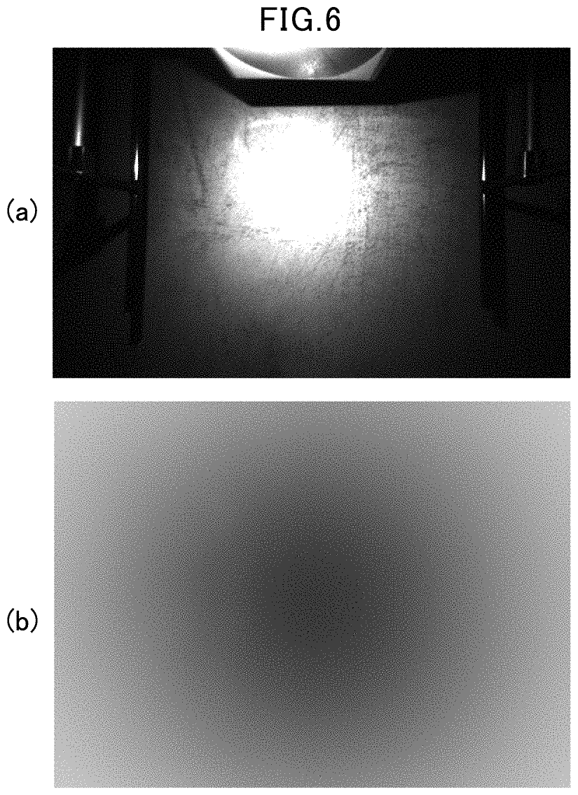

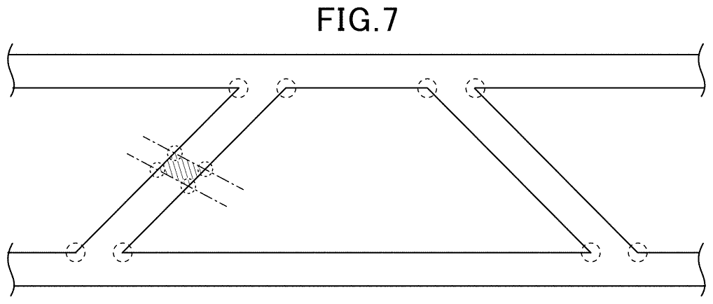

FIG. 4 shows an example of the optical structure of the light source. The laser light source 40 is, for example, a blue laser light having a band specificity and a wavelength of 420 nm. When the laser light source 40 emits laser light as coherent light, the coherent light is converted into incoherent light in a phosphor reflector 41 so as to be safe for the human eyes. The light that has passed through the phosphor reflector 41 is diffused in a projection pattern of a predetermined setting in a diffuser 42 including a diffusion lens, and then is applied onto a target object.

Here, by adopting a wide-angle lens (for example, 110 degrees) as the diffusion lens, it is possible to image a wide region of a target object at one try when imaging is performed on the camera side, and thus it is possible to increase the amount of information to be acquired by one imaging operation, which is useful in localization using the SLAM technique.

Moreover, particularly when a wide-angle lens is adopted as the diffusion lens, it magnifies an influence of an aperture efficiency characteristic in which light passing near the center of the lens is relatively brighter than light passing through outside the lens as shown in (a) of FIG. 6. In other words, assuming that a projection pattern of light passing through the diffusion lens is not uniform and the distance from the light source and a light-collecting sensor (camera) to a target object is sufficient, an outer portion of an image is acquired as a dark image on the camera side while an inner portion of the image is acquired as a bright image on the camera side. Therefore, in one example according to the present invention, the diffuser (diffusion lens) 42 is desirably configured depending on the degree of the wide angle so as to form light which is emitted such that light projected from the circumferential portion of the lens is brighter than light projected from the center portion in the projection pattern of the above-mentioned predetermined setting as shown in (b) of FIG. 6. Such a configuration makes it possible to compensate for the above-mentioned aperture efficiency characteristic caused by the diffusion lens such as a wide-angle lens.

Further, it is desirable that the light source 8 is configured to be controllable in its location and irradiation direction by the light source controller 9. In this regard, as described later, when the light source is behind the camera with respect to a target object, the light source is controlled to be adjusted in its location and irradiation direction so that the shadow of the unmanned aerial vehicle itself is not visually recognized by a machine vision system. Further, the control of the direction of the light source makes it possible to highlight feature points important for environment recognition in the Visual SLAM.

As described later, the light source may be configured so as to perform irradiation with a variable intensity by adjusting the current so that a series of images can be acquired for the Visual SLAM processing while changing the intensity of the light source. In this respect, for example, when a target object is distant, an acquired image tends to be dark, so that the light source may be configured to perform irradiation with strong intensity in a direction to the target object.

Note that the light source may be any specific light that can distinguished from other light sources (ambient light) such as sunlight. For example, the light source may be one capable of excluding shadows of ambient light as described later, and it is not limited to a blue laser light, but may be a light source having another predetermined narrow band. In addition to the band, the light source may be a light source which is configured to be different in spectral distribution, light intensity, blinking pattern of light or the like from the ambient light. As an example of the case where the light source blinks in a predetermined pattern, blinking at a constant cycle can be considered.

Further, the light source may be a light source with which irradiation with a plurality of bands can be performed (for example, a multi-spectrum including R, G, B, etc.). A multi-spectral light source may be configured by splitting light with a dichroic mirror or the like and switching respective bands temporally, or it may be configured to be capable of performing irradiation with a plurality of bands at the same time and also adjusting the irradiation directions of the respective bands to a target object individually and spatially.

Note that this case, a light-collecting sensor is configured to have a filter capable of individually collecting the plurality of bands as described later.

### Configurations of Light Source and Camera (Light-Collecting Sensor/Filter)

### Light-Collecting Sensor/Filter Corresponding to the Band of the Light Source (Blocking Other Light Sources)

A machine vision algorithm such as SLAM is desirably processed on the assumption that most of feature portions visible by a camera are fixed and do not move. If the light source is behind the camera with respect to a target object, the shadow of the unmanned aerial vehicle itself would be visible by the machine vision system. This shadow is often primary sources of feature points, but the shadow moves with the unmanned aerial vehicle and the feature portions of the shadow are not fixed. This deteriorates machine vision performance.

If the light source can be fixed to the unmanned aerial vehicle in the vicinity of the camera, the shadow from the light source can be minimized or masked. However, the shadow of the unmanned aerial vehicle itself which is caused by other light sources such as a light source which is not fixed to the unmanned aerial vehicle may move irregularly as the unmanned aerial vehicle moves. In this case, the accuracy in recognition of the shadow region based on images captured by the camera deteriorates, which leads to deterioration in accuracy of the localization of the unmanned aerial vehicle based on VSLAM.

On the other hand, according to the configurations of the light source and the camera (filter) according to the present invention, it is possible to reduce the influence of the shadow. In other words, for example, a case where the light source is a blue laser light as described above is considered. In this case, the light source passes through the phosphor reflector and the diffuser, whereby blue laser light is converted into wide-spectrum light, and most of this light is reflected by a target object at 420 nm which is the same as the laser. On the imaging side of the machine vision system, a predetermined notch filter (blue color 420 nm) is attached to the lens of the camera, so that most of light reflected from the target object passes through the blue notch filter and is captured as image data by the light-collecting sensor. On the other hand, most of light from other light sources is blocked by the 420 nm blue notch filter. Shadows generated by the other light sources are acquired as images by the light-collecting sensor without being recognized as feature points, and the influence of the shadows caused by the other light sources can be blocked.

Further, when the light source is light blinking in a predetermined pattern, reflected light from a target object is sequentially captured as a video image on the imaging side, and the light-collecting sensor is configured so as to sense a location where the intensity of light (for example, a gray scale value in an image) fluctuates within a series of images of the video image in connection with the blinking of the light source in the predetermined pattern. With the light source and the light-collecting sensor configured as described above, it is possible to detect the location in the images where the light intensity fluctuates, and estimate the position of a reflection point from the angle of view, size, etc. of the light, so that the localization of the unmanned aerial vehicle can be performed by VSLAM while reducing the influence of light which is emitted from ambient light and then reflected from a target object.

### High Dynamic Range

With respect to a laser light source having a specific band such as a blue laser light source, it is useful to perform irradiation with the intensity of illumination being made variable by adjusting the current as described above so as to enable a series of images to be obtained at various light source intensities. In other words, such a configuration makes it possible to extract feature points with a very wide range of brightness. This is useful because when a target object has a step or the like and thus surfaces at various distances from the camera exist, illumination to a surface farther from the camera requires higher light output than illumination to a surface closer to the camera. For example, with respect to a target object having a step, the light source and the collecting sensor may be configured so that image data of a short-distance region is acquired by setting the light source to relatively weak light in a first imaging operation, and image data of a long-distance region is acquired by setting the light source to relatively strong light in a second imaging operation. Accordingly, by making the collecting sensor adaptable to a high dynamic range and also a variable dynamic range, and acquiring a series of images at various illumination levels, feature portions from each surface may be extracted.

### A Plurality of Light Sources and a Plurality of Corresponding Light-Collecting Sensors/Filters

As mentioned above, the light source can be configured as a light source capable of performing irradiation with a plurality of bands (multi-spectrum). On the other hand, in this case, the camera (light-collecting sensor/filter) is configured to be capable of detecting each of the corresponding bands, so that a plurality of independent image information can be obtained for the target object.

The light-collecting sensor may be configured to be capable of detecting each of the corresponding bands, and further may be set so as to be capable of applying light whose intensity is different for each corresponding band. This makes it possible to adapt the required intensity of the applied light according to the distance between the camera/light source and the target object. Further, in this case, the light-collecting sensor may be configured to be capable of selecting the band to be detected for each pixel.

For example, when an image of a target object including a three-dimensionally large step is captured, illumination to a surface on a far side from the camera (a region on a lower side of the step) requires higher light output than illumination to a surface closer to the camera (a region on an upper side of the step). In this case, the light source and the light-collecting sensor are configured to irradiate pixels in the region on the lower side of the step with light having strong intensity and detect only the band corresponding to the band of this irradiation light, and also configured to irradiate pixels in the region on the upper side of the step with light having relatively weak intensity and detect only the hand corresponding to the band of this irradiation light, whereby it is possible to perform processing adapted to each of adjacent pixels within one image, so that a variable dynamic range can be implemented for each region or pixel by pixel in the image.

With respect to a flying object such as a drone, the surrounding scene may change abruptly as the drone moves. Implementation of such a variable dynamic range in a camera is useful to eliminate the delay in the localization processing caused by imaging of a target object using VSLAM.

### Processing Flow

With respect to the operation of localization of an unmanned aerial vehicle based on the above-described configuration, a flow of illuminating the ground with a light source and acquiring reflected waves as image data to localize the unmanned aerial vehicle as an example will be described.

First, setting of the light source and the collecting sensor of the unmanned aerial vehicle is performed (step 100).

The laser of the light source is set to, for example, a blue laser light having a wavelength of 420 nm. As for the setting of the light source, the position and the irradiation direction can be adjusted by the controller if necessary, along with the adjustment of the emission intensity of irradiation light of the light source.

In a case where the distance to a target object is recognized, the emission intensity of the light source can be set to be strong when the distance to the target object is relatively long, and set to be weak when the distance to the target object is relatively short.

In the case unmanned aerial vehicle such as a drone, for example, when the light source is attached to the lower surface of the main body so that the ground can be irradiated from the main body in order to grasp the condition of the ground, it is possible to adjust the three-dimensional position of the light source and adjust the irradiation direction of the light source based on the direction of gravity, but in the initial stage, the irradiation direction may be set to the direction of gravity. Further, the light source may be adjusted to a position closer to the target object than the camera so that the shadow of the unmanned aerial vehicle itself is not visually recognized by the machine vision system, and the irradiation direction may be adjusted.

Next, based on the settings of the light source and the light-collecting sensor in S100, the reflected waves of the light applied from the light source to the target object are acquired as image data of the target object in the collecting sensor (step 200). In this case, as described above, the blue laser light is used as the light source, and the filter of the camera allows only the blue laser light to pass therethrough. Therefore, even if a target object is irradiated with light sources from an external environment such as sunlight, shadows, etc. caused by these light sources from the external environment are not imaged, and thus it is possible to reduce an influence of misidentification of a feature point or the like caused by a shadow occurring on the target object by sunlight.

Next, for example, extraction and tracking of feature points of the target object and creation of an environmental map are performed using the VSLAM processing or the like based on the images of the target object acquired in S200, thereby estimating the relative position of the unmanned aerial vehicle with respect to the target object (S300). In this case, when a moving object is detected, it is removed by using difference data of time-sequentially acquired images or the like.

Note that with respect to the estimation of the relative position in S300, as described above, in addition to use of the image data of the target object obtained by collecting reflected waves of light having a specific band such as blue laser light, image data of the target object obtained by separately collecting reflected waves of ambient light such as sunlight may be further used. In other words, for example, the localization processing such as VSLAM using image data acquired by using light having a specific band as a light source and the localization processing such as VSLAM using another image data acquired by using ambient light or the like may be performed independently of each other, and then reliabilities thereof may be weighted to finally estimate the position. By adopting such a configuration, it is possible to use the conventional localization based on VSLAM using image data under an imaging condition where there is not any influence of shadows, etc., and it is possible to perform the localization in combination with existing SLAM adaptable to all bands including ambient light.

Although not shown, the unmanned aerial vehicle may be configured to control the flight of the unmanned aerial vehicle by using the relative position of the unmanned aerial vehicle to the target object estimated in a localization step S300 and the speed of the unmanned aerial vehicle.

Note that when the extraction of feature points and the creation of an environment map have not been performed accurately and smoothly in the VSLAM processing, the processing may return to step 100 again to perform the setting of the light source and the collecting sensor of the unmanned aerial vehicle.

In this respect, it is desirable to configure the localization processing for the target object so that it is possible to determine whether the exposure amount of light reflected from a target object is excessive or deficient. For example, in a case where there is an excess or deficiency in the exposure amount of light reflected from the target object, if a captured image includes feature points having low contrast and thus includes many unstable feature points, the time required for the processing increases, the mapping is adversely affected, and the created environment map and the captured image are compared with each other to indicate a possibility that the localization based on the VSLAM processing may be inaccurate. Therefore, the processing returns to S100 to adjust the emission intensity of the light source. Further, in this case, the direction of the light source may be controlled to shift an imaging area so that feature points important for environmental recognition in VSLAM are searched and highlighted. For example, when important feature points of a target object are distant, an acquired image tends to be dark, and thus the light source is reset so as to perform irradiation with a strong intensity in that direction.

The fact that the light source can be reset in this way contributes to the efficient comparison between the created environment map and the captured image, and it is particularly effective to reduction of the error of the VSLAM processing when the target object has a large step shape or the like.

### Modification

Next, there will be described a case where a plurality of independent image information is acquired for a target object by using a light source capable of performing irradiation with a plurality of bands and a light-collecting sensor/filter capable of detecting each of the corresponding bands.

Here, for simplicity of description, a case where a red laser light and a blue laser light are used as two light sources to estimate the relative position of the unmanned aerial vehicle with respect to a target object having a step is assumed, but a light source having three or more bands and a light-collecting sensor/filter capable of detecting each of the bands may be provided.

First, the intensity and the position/direction are set for each of the red laser light and the blue laser light (S100). In this case, they can be set so as to be capable of performing irradiation with light having different intensities, but for example, in an initial stage, both the red laser light and the blue laser light may be set to be the same in intensity and different in irradiation direction.

Note that the light sources of the red laser light and the blue laser light may be configured so that the respective bands thereof are temporally switched to each other, or may be configured so that a plurality of bands can be simultaneously applied and also configured so that the respective bands are switched in an image space.

Next, based on the setting of S100, based on the settings of the light source and the light-collecting sensor, reflected waves of light applied from the light source to the target object are acquired by the collecting sensor to acquire an image of the target object (step 200).

Next, based on the images of the target object acquired in S200, the localization of the unmanned aerial vehicle is performed, for example, by performing the extraction and tracking of the feature points of the target object and the mapping by using the SLAM processing or the like (S300). In this case, when a moving object is detected, it is removed by using difference data of time-sequentially acquired images.

Here, when it is estimated that the target object has a step, the processing returns to S100 to efficiently estimate the position of the unmanned aerial vehicle. For example, the red laser light is reset to have a relatively strong intensity, and the blue laser light is reset to have a relatively weak intensity. Not that the setting of the strong and weak intensities may be reversed between the red and blue colors, and different intensities may be set for the respective bands. Further, in the target object, the position and direction of the light source are reset so that a region on the lower side of the step (a region which is relatively far from the light source) is irradiated with red laser light having a strong intensity while a region on the upper side of the step (a region which is relatively near to the light source) is irradiated with blue laser light having a relatively weak intensity. Note that the irradiation with the red laser light and the blue laser light may be performed simultaneously or time-sequentially in turn according to the configuration of the laser light source, and with respect to a pixel region including the upper side and the lower side of the step of the target object, it is sufficient only to acquire one image for the pixel region such that the amount of exposure light to the sensor is constant over the pixel region.

Next, captured images are acquired by detecting only the applied red laser light having a strong intensity for pixels in the lower-side region of the step of the target object and detecting only the applied blue laser light having a relatively weak intensity for pixels in the upper-side region of the step in the light-collecting sensor/filter (S200). Thereafter, based on the image of the target object acquired in S200, the extraction and tracking of feature points of the target object and the mapping are performed again, for example, by using the SLAM processing or the like based on the images of the target object acquired in S200, thereby localizing the unmanned aerial vehicle (S300). Note that the processing may return to S100 again in order to efficiently estimate the position of the unmanned aerial vehicle according to changes of the surrounding environment (target object), etc. caused by the movement of the unmanned aerial vehicle. Although not shown, the unmanned aerial vehicle may be configured so that the flight of the unmanned aerial vehicle is controlled by using the relative position of the unmanned aerial vehicle with respect to the target object estimated in the localization step S300 and the speed of the unmanned aerial vehicle.

As described above, when a target object including a three-dimensionally large step is imaged, there is a situation in which a surface on a farther side from the camera (a lower-side region of the step) requires a higher output of the light source than a surface on a closer side to the camera (an upper-side region of the step). The configuration of resetting the light source and the light-collecting sensor while performing the mapping in the SLAM processing makes it possible to efficiently cope with such a situation. Further, the configuration in which the blue laser light and the red laser light are used and only the bands thereof can be detected as described above makes it possible to reduce the influence of shadows caused by external light such as sunlight when a target object has a large step.

Note that the configuration in which the light source is switched according to each predetermined region in an image has been described above, but the light source may be switched according to each pixel or each image.

As described above, the influence of another light source or sunlight may cause point cloud data in the VSLAM processing to be erroneously acquired due to the presence of a shadow. This is particularly remarkable in such a case that a target object includes a step. The light source and the light-collecting sensor/filter according to the present invention are useful in that they can suppress such an influence of other light sources and sunlight to the minimum level. In other words, for example, a shadow of another target object caused by sunlight may occur in the region of the target object to be imaged. However, image data acquired by using the light source and the collecting sensor according to the present invention are image data from which such a shadow is removed, and it is possible to accurately extract feature points in VSLAM. From this point of view, when the light source is attached to the main body, it is desirable that the light source is arranged to be as close to the camera as possible so that a shadow formed by the light source is avoided from being visually recognized.

According to the present invention, an autonomous unmanned aerial vehicle having no GPS function can accurately perform localization while reducing processing time. Note that this does not mean that the autonomous unmanned aerial vehicle excludes a situation in which the GPS function is installed therein. If the GPS function is installed in the autonomous unmanned aerial vehicle, it would be possible to accurately collect information on the surrounding environment, and it is further possible to perform the localization of the unmanned aerial vehicle more efficiently and accurately than prior arts by using the unmanned aerial vehicle in combination with the light source and the camera (collecting sensor) according to the present invention.

As described above, the embodiment and examples of the light source and the collecting sensor/filter according to the present invention have been described. However, it is easily understood that the present invention is not limited to the above-mentioned examples, and various modifications can be made thereto. As long as they are within the scope of matters described in each claim of the claims and the matters equivalent thereto, they are naturally included in the technical scope of the present invention. Although the above-mentioned examples are applied to the shadow on the target object and the case where the target object has a step, these are merely examples, and the present invention is not limited to these specific examples.

### INDUSTRIAL APPLICABILITY

The present invention can be used for localization and control of unmanned aerial vehicles used for all purposes.

### REFERENCE SIGNS LIST

1 unmanned aerial vehicle

2 main body portion

3 motor

4 rotor (rotor blade)

5 arm

6 landing leg

7 local sensor

11 flight control device

12 transceiver

13 sensor

14 speed controller (ESC)

21 processor

22 storage device

23 communication IF

24 sensor IF

25 signal conversion

31 environment acquisition unit

32 localization unit

40 laser light source

41 phosphor reflector

42 diffuser

1. A localization device for an unmanned aerial vehicle comprising:
a light source for irradiating a target object around the unmanned aerial vehicle;
a light-collecting sensor for acquiring reflected light from the target object as image data; and
a localization unit for estimating a relative position of the unmanned aerial vehicle to the target object using the image data acquired by the light-collecting sensor, wherein the light source includes a laser for emitting light distinguishable from ambient light, and a diffuser for diffusing the light from the laser, and the light-collecting sensor is configured to sense light distinguishable from the ambient light with respect to the reflected light from the target object.

2. The localization device according to claim 1, further comprising a light source controller for adjusting at least one of an emission intensity, a position and a direction of the laser.

3. The localization device according to claim 1, wherein the light distinguishable from the ambient light is light of a predetermined band, and the light-collecting sensor is configured to sense the light of the predetermined band.

4. The localization device according to claim 3, wherein the predetermined band includes a plurality of bands, and the light-collecting sensor is configured to sense each of signals of the plurality of bands.

5. The localization device according to claim 4, wherein the light source is configured so as to apply light that is different in intensity among the plurality of bands, and the light-collecting sensor is configured to select which band of light is to be sensed according to a distance to the target object.

6. The localization device according to claim 5, wherein the light-collecting sensor is configured to be able to select which band of light is to be sensed for each pixel or for each predetermined region in an image.

7. The localization device according to claim 1, wherein the diffuser includes a wide-angle lens.

8. The localization device according to claim 7, wherein the diffuser is configured to form light which is emitted such that light projected from a circumferential portion of the wide-angle lens is brighter than light projected from a center portion.

9. The localization device according to claim 1, wherein the light source further comprises, in front of the diffuser, a phosphor reflector for converting a coherent laser into an incoherent spectrum.

10. An unmanned aerial vehicle according to claim 1, wherein flight of the unmanned aerial vehicle is controlled by using a relative position of the unmanned aerial vehicle with respect to the target object estimated by the localization device and a speed of the unmanned aerial vehicle.

11. A method comprising:
a step of emitting light distinguishable from ambient light from a laser used as a light source;
a step of diffusing the emitted light to irradiate a target object around an unmanned aerial vehicle;
a step of collecting reflected light from the target object to acquire image data; and
a step of estimating a relative position of the unmanned aerial vehicle to the target object by using the acquired image data, wherein the step of acquiring the image data acquires the image data by sensing light distinguishable from the ambient light with respect to reflected light from the target object.

12. The method according to claim 11, further comprising a step of setting at least one of an emission intensity, a position and a direction of the light source, wherein the emitting step, the step of irradiating the target object, the step of acquiring the image data, and the estimating step are executed by using the set light source.

13. The method according to claim 11, wherein the light distinguishable from the ambient light is light of a predetermined band, and the step of acquiring the image data acquires the image data by sensing the light of the predetermined band.

14. The method according to claim 13, wherein the predetermined band has a plurality of bands, and the step of acquiring the image data senses each of signals of the plurality of bands.

15. The method according to claim 14, wherein the irradiating step applied light that is different in intensity among the plurality of bands, and the step of acquiring the image data further comprises a step of selecting which band of light is to be sensed according to a distance to the target object.

16. The method according to claim 15, wherein the step of acquiring the image data further comprises a step of selecting which band of light is to be sensed for each pixel or for each predetermined region in an image.
